(19) United States
(12) Patent Application Publication
(10) Pub. No.: US 2026/0330473 A1
(43) Pub. Date: Oct. 22, 2026

(54) SYSTEMS AND METHODS USING LANGUAGE MODELS TO DETERMINE ITEM COMPLIANCE

(71) Applicant: Walmart Apollo, LLC, Bentonville, AR (US)

(72) Inventors: Rajesh Narasimha Reddy, Milpitas, CA (US); Rajat Gupta, Bengaluru (IN); Nishanth Domakonda, Hyderabad (IN); Raviteja Uppalapati, San Francisco, CA (US); Akshit Sarpal, Santa Clara, CA (US); Samrat Kokkula, Sunnyvale, CA (US)

(21) Appl. No.: 19/181,094

(22) Filed: Apr. 16, 2025

(51) Int. Cl. G06Q 30/018; G06F 16/22; G06F 16/2455; G06V 30/19

(52) U.S. Cl. CPC G06Q 30/018; G06F 16/2237; G06F 16/24564; G06V 30/19153

(57) ABSTRACT

There are provided systems and methods that are useful to determine item compliance. In one form, an example implementation may determine whether text extracted from an image of a listing includes prohibited indicators based on context. The example implementation may transmit training data to train a rule generation language model to generate dynamic rules; receive extracted text, a reason for an incorrect classification determination, and a dynamic rule; store in a database dynamic rules; receive an indicator that may indicate a non-compliant item, receive text from an image associated with an item, instruct a rule retrieval language model to retrieve from the database dynamic rules; and query the rule retrieval language model to apply the dynamic rules to determine if the item is compliant.

### TECHNICAL FIELD

This disclosure relates generally to items in listings, and more particularly, to determining item compliance for the inclusion in the listings.

### BACKGROUND

In e-commerce and other settings, vendors may submit or upload items, e.g., products, for inclusion in a catalog of a retailer. In some instances, vendors may submit or upload items to the catalog that may be prohibited by the retailer or may be otherwise prohibited. Users may anticipate seeing non-prohibited items when interacting with the retailer.

### BRIEF DESCRIPTION OF DRAWINGS

Disclosed herein are embodiments of systems, apparatuses and methods pertaining to item compliance. This description includes drawings, wherein:

FIG. 1 is a block diagram depicting an example system for assessing item compliance using language models in accordance with some embodiments;

FIG. 2 is a block diagram depicting an example compliance assessment in accordance with some embodiments;

FIG. 3 is a block diagram depicting an example system for assessing item compliance in accordance with some embodiments;

FIG. 4 is a block diagram depicting an example system for assessing item compliance in accordance with some embodiments;

FIG. 5 is a block diagram depicting an example system for assessing item compliance using language models in accordance with some embodiments;

FIG. 6 is a block diagram depicting additional aspects of a portion of the example system of FIG. 5;

FIG. 7 is a block diagram depicting an example system for retrieval augmented generation in accordance with some embodiments;

FIG. 8 is a block diagram depicting an example system for assessing item compliance in accordance with some embodiments;

FIG. 9 is a block diagram depicting an example system that includes a prompt involving an item and an assessment for compliance of the item in accordance with some embodiments;

FIG. 10 is a flow diagram depicting an example method for assessing item compliance in accordance with some embodiments; and

FIG. 11 is a block diagram depicting a machine readable medium with example instructions for assessing item compliance in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the disclosure. Thus, appearances of the phrases “in one embodiment,” “in an embodiment,” “in some embodiments”, “in some implementations”, and similar language throughout this specification may, but do not necessarily, all refer to the same embodiment.

In one aspect, and without limitation, the disclosure addresses using machine learning models, such as, for example, language models and large language models (LLMs), to assess item compliance for items, e.g., products, in an e-commerce catalog. Vendors may submit or upload items for a retailer's catalog in order to make the items available for purchase through the retailer. It is desirable to use machine learning models to identify non-compliant items within the retailer's catalog, to avoid false positives, and to take relevant action (e.g., remove an item from the catalog, flag an item for manual review, allow an item to be included in the catalog, etc.). Compliant items may then be presented in the catalog to users. Prior to becoming available for purchase (or sometimes after an item is part of the catalog and has been made available for purchase), the items may be assessed to determine if the items are compliant. In determining an item's compliance, dynamic rules generated by a rule generation language model are used by a rule retrieval language model to apply the dynamic rules to an item and determine if the item is compliant relative to target keyword(s). Use of dynamic rules can improve the accuracy of compliance determinations and avoid a false positive in which a compliant item is inaccurately determined to be non-compliant.

In one aspect, and without limitation, this disclosure addresses issues related to incorrect compliance determinations for items within a retailer's catalog. Often, compliance determinations identify the presence of a keyword in relation to an item regardless of the context of the keyword and determine that an item is not compliant due primarily to the presence of the keyword. For example, an item states that it does not contain a prohibited ingredient or is “free” of that ingredient, and this statement (or text) is incorrectly interpreted as an indication that the item contains the prohibited ingredient. Disregard of the context of the keyword often causes compliant items to be categorized as non-compliant. Further, changing item guidelines and recalls require accurate assessment of items within the catalog to reduce the risk of a retailer selling recalled or prohibited items. When new guidelines or recalls are issued regarding a prohibited substance, it is desirable to be able to conduct an accurate assessment of the catalog for items that may contain the prohibited substance.

In one aspect, and without limitation, this disclosure addresses use of machine learning models to generate and utilize dynamic rules for assessing the compliance of an item. Item catalogs may include text associated with item images that may need to be assessed. In one aspect, this disclosure uses training data, e.g., examples of item compliance misclassifications, to generate dynamic rules that avoid compliance misclassifications. A language model may generate the dynamic rules. The same language model (or a different one) may retrieve relevant dynamic rules and assess an item for compliance utilizing the relevant dynamic rules. The dynamic rules may be used to improve accuracy during assessment of an item for compliance.

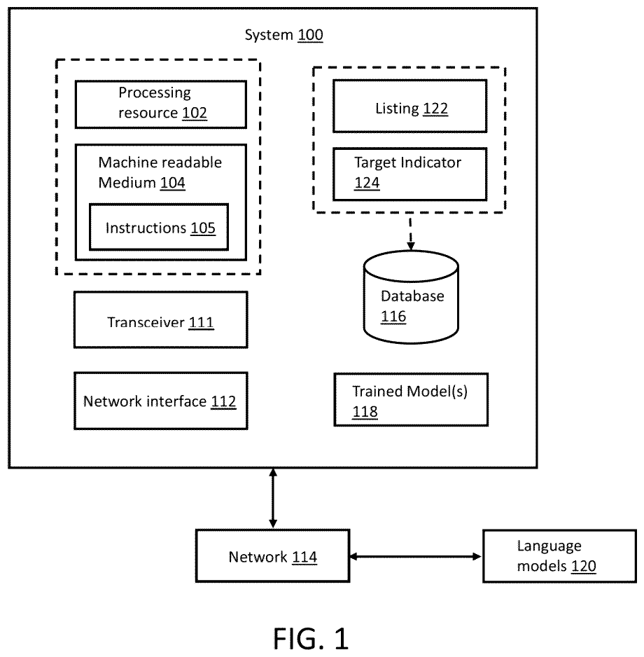

Referring now to the figures, FIG. 1 depicts an example system 100 that uses language models to generate dynamic rules and to apply the dynamic rules when assessing an item for compliance. The language models are generally specific types of machine learning models known in the art that use data to generate outputs relating to language. In one form, the language models may be large language models. In some aspects, the system 100 further uses trained models. As used herein, trained models generally refer to machine learning models that have been taught to perform specific tasks by training them with data sets.

The system 100 includes a processing resource 102 that may include a microcontroller, a microprocessor (general purpose or specific purpose), central processing unit core(s), an application-specific integrated circuit (ASIC), a field programmable gate array (FPGA), etc. The system 100 includes machine readable medium 104 that may be non-transitory and include random access memory (RAM), read-only memory (ROM), electrically erasable programable read-only memory (EEPROM), flash memory, a hard disk drive, etc. The processing resource 102 may execute instructions 105 (i.e., programming or software code) stored on machine readable medium 104 to perform functions of the system 100. Additionally, or alternatively, the processing resource 102 may include electronic circuitry for performing the instructions and functionality described herein. In some forms, the processing resource 102 and machine readable medium 104 may be part of an integrated device, while in other forms, they need not be.

In that regard, the processing resource 102 may be configured to execute and perform certain operations. In this context, the term processing resource 102 refers broadly to any microcontroller, computer, or processor-based device with processor, memory, and programmable input/output peripherals. As shown in FIG. 1, the processing resource 102 may be coupled to a communication transceiver 111 and a network interface 112, which, in turn, may be coupled to wireless network(s) 114. The network interface 112 may enable the processing resource 102 to communicate with other elements (both internal and external to the system 100). The network interface 112 can communicatively couple the processing resource 102 to the wireless network 114 and whatever other networks 114 may be appropriate for the circumstances.

The processing resource 102 may make use of cloud databases and/or operate in conjunction with a cloud computing platform. The processing resource 102 may be coupled to and/or communicate with one or more databases (such as database 116). Also, in some forms, as shown in FIG. 1, the one or more databases constitute local storage accessible to the system 100, while in other forms, they may constitute remote storage accessible via the network(s) 114. While one processing resource 102 is shown, in some forms, the functionalities of the processing resource 102 may be implemented on a plurality of processor devices communicating on a network 114.

In addition, the system 100 may include one or more trained models, such as trained machine learning models. In one form, the system 100 may include a trained model 118. In some forms, the trained model 118 may be part of the system 100, but in other forms, it may be external to the system 100, such as, for example, part of a separate cloud computing system. The operation of the trained model 118 is described further below. In the example shown in FIG. 1, the trained model 118 is part of the system 100. For example, the trained model 118 may be stored in machine readable medium(s) and executed by processing resources of servers of the system 100. In other forms, one or more trained models 118 may be stored in machine readable mediums and executed by processing resources of servers separate from the system 100 and may be accessible by the network 114, such as where the trained models 118 may be maintained on a cloud computing platform or database. In some forms, the processing resource 102 and the machine readable medium 104 may be part of a cloud computing system and at least one language model 120 may be executed by the cloud computing system.

The system 100 may also communicate with one or more language models 120 via the network 114. In some forms, it is contemplated that a single language model may be used to perform the operations described in this disclosure. In other forms, it is contemplated that multiple language models may be used that may be implemented one after another in a series operation or that may be implemented at the same time in a parallel operation. In some embodiments, the one or more language models 120 may be trained by third parties and may reside and be executed in a third party cloud server environment. In some embodiments, example language models may include: GPT-4, GPT-3.5, and ChatGPT from OpenAI; BERT, T5, and Bard from Google; Claude 3.5; Llama from Meta; and Bing Chat from Microsoft. In some embodiments, one or more language models 120 may be downloaded from third parties and trained using data specific to the system 100 and executed on server(s) controlled by the system 100 developer.

In some embodiments, the trained model(s) 118 may be implemented as language model agents. Language model agents are model interfaces that may be systems built on top of a machine learning model (e.g., a language model) that may interact with external tools and application programming interfaces (APIs). A machine learning agent may further maintain a state and/or context across multiple steps by calling a machine learning model multiple times and recalling the input(s) and/or output(s) of each call. In some aspects, a machine learning agent may autonomously work toward specific goals (e.g., by planning a series of steps and delegating the steps to additional machine learning models). In other words, a machine learning agent utilizes machine learning models along with additional tools (e.g., open-source resources, search engines, additional models, etc.) in order to complete tasks.

In some embodiments, the system 100 includes a listing 122 (which may also be referred to herein as a catalog). The listing 122 may include a plurality of images associated with a plurality of items. In some aspects, the items may correspond with items, e.g., products, available for purchase via a retailer (such as an e-commerce retailer). In some embodiments, the system 100 includes a target indicator 124 (which may also be referred to herein as a target keyword). In some aspects, the target indicator 124 is in the form of a search query/keyword used to assess an item for compliance. In some forms, the listing 122 and target indicator 124 may be stored in the database 116.

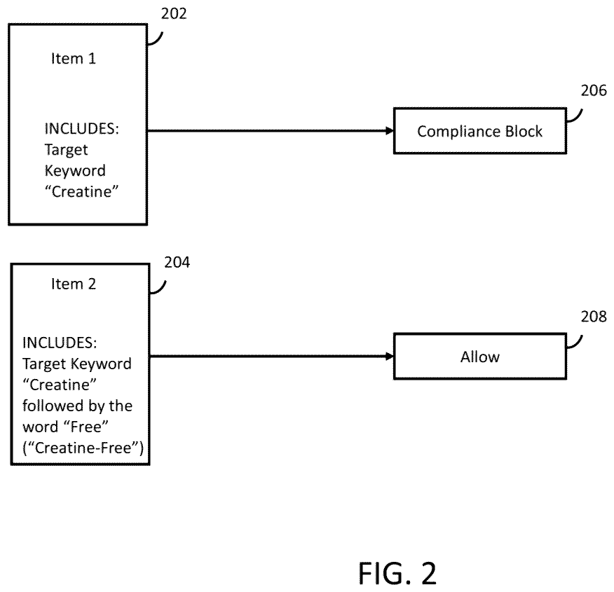

FIG. 2 depicts a block diagram of an example compliance assessment performed by a system such as the system 100. FIG. 2 depicts an example of how the processing resource 102 executing the instructions 105 may use the language models 120 to perform the functionality described above and further detailed below. In the present example, a first item 202 and a second item 204 are being assessed for compliance relative to a target keyword. In one form, the target keyword used to evaluate the items 202, 204 for compliance may be “Creatine”, which may be a prohibited ingredient, e.g., a substance not allowed for sale in the marketplace.

In one form, text may be extracted from images of the items 202, 204, and the extracted text may be used to determine compliance of the associated item. Regarding Item 1, the text extracted from the first item 202 includes the target keyword “Creatine”. In this first instance, the text indicates that the first item 202 includes the prohibited ingredient, and the context around use of the target keyword does not indicate otherwise. Regarding Item 2, the text extracted from the second item 204 include the target keyword “Creatine” followed by the word “Free” (i.e., “Creatine-Free”). In this second instance, the context suggests that the item does not contain the prohibited ingredient. Thus, in the present example, the first item 202 receives a compliance block 206 for including the target keyword in the first item 202, while the second item 204 is allowed 208 because the extracted text and context indicate that the second item 204 does not contain the prohibited ingredient.

While extracted text from images of each of the items 202, 204 include the target keyword, context is used to determine if the items 202, 204 themselves may contain the prohibited ingredient, in order to determine compliance. The presence of the keyword in the extracted text does not always mean the item is non-compliant. Another example is the word “shark”, which may be associated with a compliant item if it is part of a brand name, but which may be associated with a non-compliant item if it refers to an active ingredient. Although these examples use a keyword that is a prohibited ingredient, it should be understood that this disclosure extends beyond prohibited ingredients and some keywords are not necessarily prohibited ingredients.

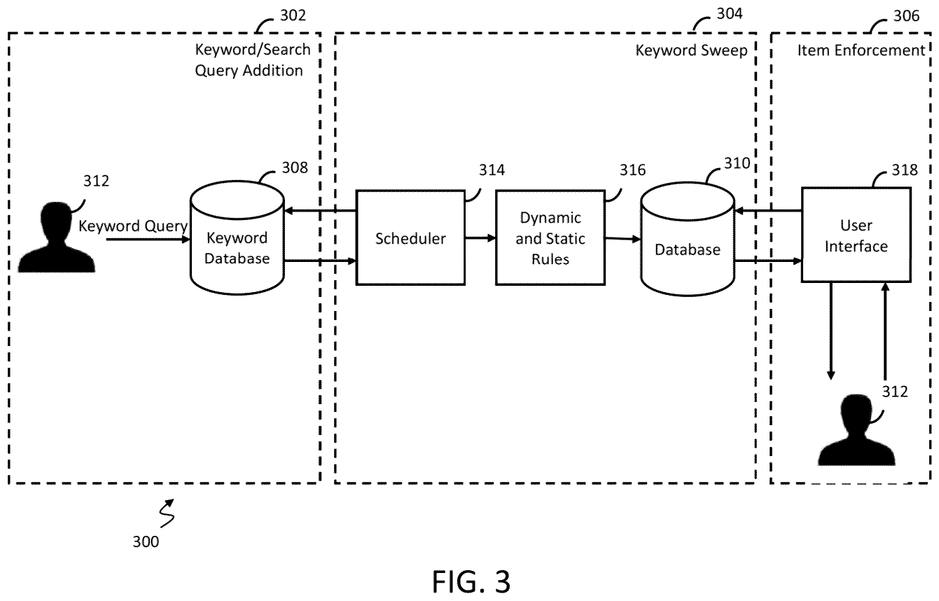

FIG. 3 depicts a block diagram showing a general example of a system 300 that assesses items for compliance relative to a target keyword. FIG. 3 depicts a high level overview of how the processing resource 102 may execute the instructions 105 of FIG. 1 to perform the functionality described herein. In some forms, it is generally contemplated that the keyword database 308 and/or the database 310 may be analogous to the database 116.

In one form, the system 300 includes a keyword addition component 302, a keyword sweep component 304, and an item enforcement component 306. In one form, the keyword addition component 302 (also referred to herein as a search query addition component) may facilitate the addition of a new keyword into the system 300. A user 312 may enter (for example, via a user interface (not shown)) a keyword to be used to determine compliance of items within the system 300 (which may include items in a catalog). Keywords may also be entered in other ways. In some aspects, the keyword is entered into and stored in the keyword database 308. In one form, the keyword database 308 includes a plurality of keywords to be used by the system 300 for compliance determination of items.

In one form, the keyword sweep component 304 may facilitate a periodic scan throughout a catalog to assess items in the catalog for compliance. In some forms, a catalog including items may be stored in the database 310, which may serve as a catalog/listing database. The keyword sweep component 304 may scan the database 310. In some aspects, new keywords may be added into the system 300, and a sweep of the catalog may be performed to assess compliance relative to new keywords stored in the keyword database 308. In some forms, new items may be added into the system 300, and a sweep of the catalog may be performed to assess compliance of new items relative to pre-existing keywords stored in the keyword database 308.

In one form, the keyword sweep component 304 includes a scheduler component 314. The scheduler component 314 may schedule the timing of the scans performed by the keyword sweep component 304. For example, scans may be performed periodically (e.g., daily, weekly, monthly) depending on, for example, the timing of addition of new items to a catalog, pre-defined settings (e.g., defined by a user via a user interface), and so on. In some aspects, the database 310 may be scanned for compliance relative to each keyword simultaneously. In some forms, the database 310 may be scanned for compliance at varying periods relative to various keywords. In some forms, text from a catalog and text extracted from images in the catalog may be scanned, such as, for example, via optical character recognition (OCR).

In one form, the keyword sweep component 304 includes dynamic and static rules 316. In one form, the dynamic and static rules 316 are utilized to assess item compliance. In some aspects, dynamic rules are associated with specific keywords in order to provide context during assessment of items for compliance. In some forms, static rules are non-keyword specific rules to be utilized along with a keyword during a compliance assessment. In other words, during a compliance assessment, the specific keyword, the static rules, and dynamic rules associated with the specific keyword may be used to determine compliance. In some forms, rules may be stored in the same database 310 as the listing or in a separate rules database.

In one form, the item enforcement component 306 may determine actions to be taken by the system 300 in response to a determination of compliance or non-compliance. For example, a determination that an item is allowable may result in the item remaining within the catalog. A determination that an item is not compliant may result in the item being flagged for review or removed from the catalog. The item enforcement component 306 may include a user interface 318 via which a user 312 may enter enforcement actions to be taken in response to specified compliance determinations. In one form, a user 312 may review an item flagged for review and manually determine the action to be taken for an item (e.g., allow, remove, restrict, etc.).

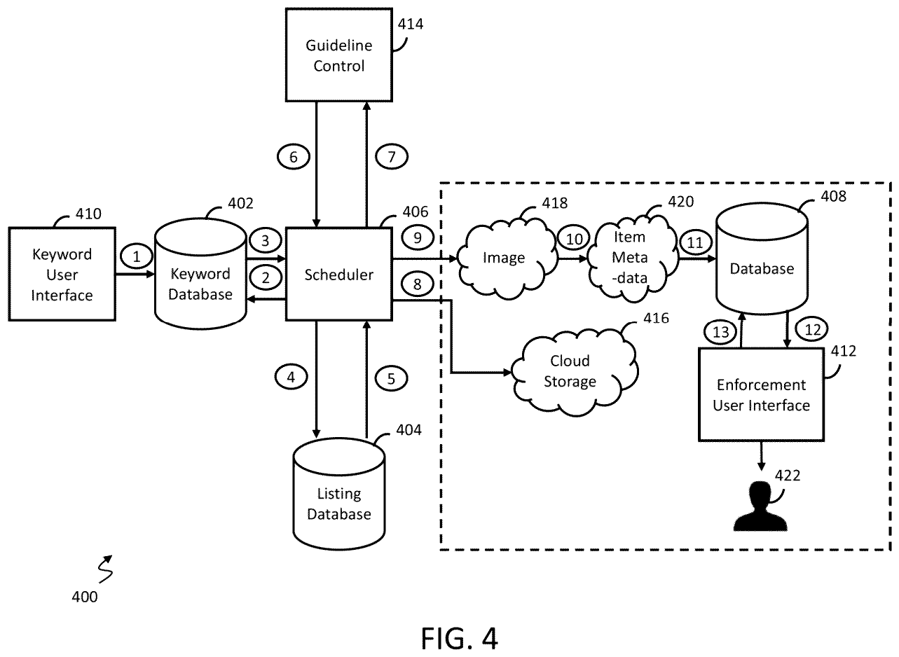

FIG. 4 depicts a block diagram showing a general example of a system 400 that uses language models to assess items for compliance relative to a target keyword. FIG. 4 depicts an overview of how the processing resource 102 may execute the instructions 105 of FIG. 1 to perform the functionality described herein. In some forms, it is generally contemplated that the listing database 404 may be analogous to the listing 122, and the keyword database 402 and/or the database 408 may be analogous to the database 116. In some forms, as shown in FIG. 4, the scheduler component 406 and/or the guideline control 414 may trigger via the processing resource 102 the functionalities described herein.

In one form, the keyword user interface 410 is a user interface via which target keywords may be entered. Keywords entered via the keyword user interface 410 may be stored in the keyword database 402 and accessed periodically by the scheduler component 406 in order to utilize the keywords and determine item compliance. In one aspect, the guideline control 414 (also referred to herein as a rule generation component) via the processing resource 102 may generate dynamic rules to be utilized when determining item compliance. For example, the guideline control 414 via the processing resource 102 may access language models that generate dynamic rules based on training data which may include misclassification examples of non-compliant items.

In some forms, keywords are first entered via the keyword user interface 410 and stored in the keyword database 402. The scheduler component 406 via the processing resource 102 may then access the keyword database 402 to obtain keywords to be utilized during a compliance assessment. The scheduler component 406 via the processing resource 102 may then access the listing database 404 to obtain relevant data (e.g., images, extracted text, item links, etc.) associated with items within the catalog in which the compliance assessment is to be performed. The scheduler component 406 via the processing resource 102 may then trigger or access the guideline control component 414 to receive dynamic rules associated with the keyword(s) being used and/or item(s) being assessed in the compliance assessment.

In one form, following obtaining target keywords, item data, and dynamic rules, the obtained information may be stored in cloud storage 416. In one form, an image 418 associated with a target item is isolated from the item data (e.g., via an application programming interface (API)). In one form, item metadata 420 may be extracted from the image 418 (e.g., via an API). The item metadata 420 and/or image 418 may then be stored in a database 408. The enforcement user interface 412 may receive compliance input from a user 422 and update the data in the database 408 accordingly. In one form, the target keywords, item data, and dynamic rules may be utilized to determine compliance of an item. The compliance determination may be stored in the database 408 and may be accessible by a user 422 via the enforcement user interface 412. For example, one or more language models (such as the language models 120 of FIG. 1) may be used to determine if an item is compliant.

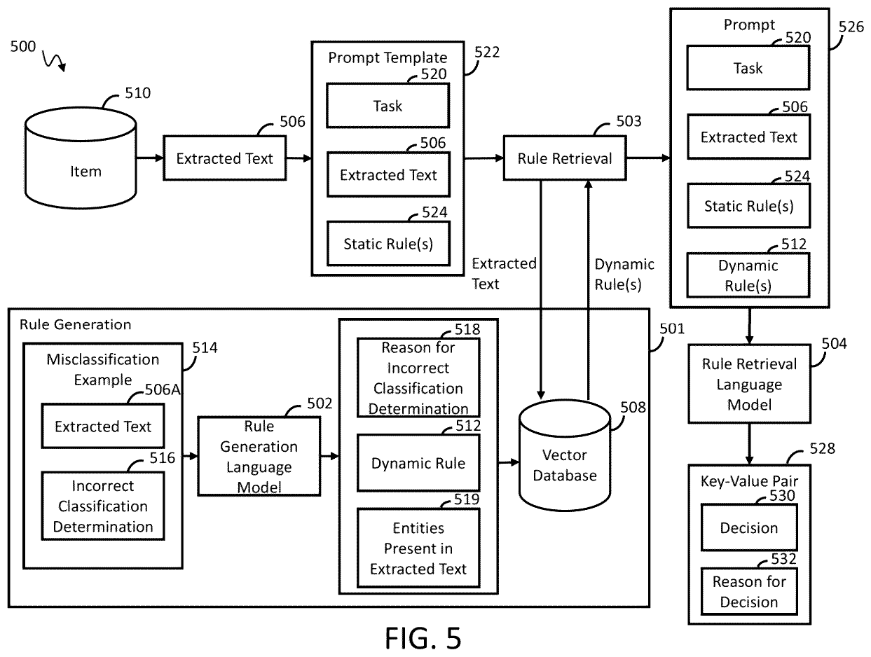

FIG. 5 depicts a block diagram showing an example of a system 500 that uses language models to assess items for compliance. FIG. 5 depicts an example of how the processing resource 102 executing the instructions 105 of FIG. 1 uses the language models 120 to perform the functionality described above and further detailed below with respect to FIG. 5. In some forms, it is generally contemplated that the rule generation language model 502 and the rule retrieval language model 504 may be analogous to language models 120.

In one form, dynamic rules 512 may be utilized to provide context during a compliance assessment and avoid incorrect classification determinations. In one form, a rule generation component 501 may generate dynamic rules 512. The rule generation component may include a rule generation language model 502 (e.g., GPT 4.0) and a rules database in the form of vector database 508, which may act as a repository for dynamic rules 512. The processing resource 102 may first transmit training data to the rule generation language model 502 to generate a plurality of dynamic rules 512. In one form, the training data includes misclassification examples 514. Each misclassification example 514 may include extracted text 506A and an incorrect classification determination 516 that the extracted text 506A was associated with a non-compliant item. The extracted text 506A may be extracted from an image of a purported non-compliant item utilized in a misclassification example 514.

In one form, for a misclassification example 514, the processing resource 102 receives the extracted text 506A, a reason 518 for the incorrect classification determination 516, and a dynamic rule 512 to be applied that avoids the incorrect classification determination 516. In one form, the rule generation language model 502 generates the reason 518 for the incorrect classification determination 516 and the dynamic rules 512 to avoid the incorrect classification determination 516. In one form, the rule generation language model 502 may detect entities 519 present in the extracted text 506A. The rule generation language model 502 may utilize the entities 519 present in the extracted text 506A when generating the dynamic rules 512 and the reason 518 for the incorrect classification determination 516. The processing resource 102 may store the dynamic rules 512 that avoid the incorrect classification determination 516 from the misclassification examples 514 of items in the database 508.

The processing resource 102 may receive a target indicator (also referred to herein as a target keyword) that may indicate a non-compliant item not authorized to be in the catalog. The processing resource 102 may receive extracted text 506 extracted from a target image (associated with an item 510 in the catalog/listing) containing the target indicator that is associated with an item. The extracted text 506 may be extracted from an image (for example, via optical character recognition (OCR)) of an item (also referred to herein as a target item) being assessed for compliance.

In one form, the extracted text 506 is utilized to populate a prompt template 522 (also referred to as an instruction set template). The prompt template 522 may include a task 520, extracted text 506, and static rules 524. Static rules 524 may be non-keyword specific and/or non-item specific rules utilized for compliance assessments. In one form, the dynamic rules 512 are related to the extracted text 506, while the static rules 524 are applied without a determination of a relationship to the target text.

Once the extracted text 506 has been added to the prompt template 522, the processing resource 102 may instruct the rule retrieval language model 504 (e.g., GPT 3.5) to retrieve from the database 508 one or more dynamic rules 512 that relate to the extracted text 506. In one form, a rule retrieval component 503 retrieves the dynamic rules 512. In one form, it is contemplated that the rule retrieval component 503 via the processing resource 102 operates using a retrieval augmentation generation approach. Under this approach, data in the form of dynamic rules 512 are incorporated from vector database 508 into a query/prompt 526 (also referred to as an instruction set) that is provided to the rule retrieval language model 504. In other words, the prompt template 522 is supplemented with the dynamic rules 512 to allow the rule retrieval language model 504 to generate a more accurate compliance assessment.

Once the dynamic rules 512 have been retrieved, the rule retrieval component 503 may populate the prompt template 522 with the dynamic rules 512 and output a prompt 526. The prompt 526 may include the task 520, the extracted text 506, the static rules 524, and the dynamic rules 512. The processing resource 102 may transmit the prompt 526 to the rule retrieval language model 504 to determine if the item 510 is compliant. The processing resource 102 may then query the rule retrieval language model 504 to apply the dynamic rules 512 to determine if the item 510 is compliant. Thus, the dynamic rules 512 may be used to steer or guide the rule retrieval language model 504 in evaluating the context of a keyword/target indicator.

In one form, a determination if a target item is compliant may be in the form of a key-value pair 528. The processing resource 102 may transmit an instruction to the rule retrieval language model 504 to provide a key-value pair 528 as output to the prompt 526 to determine if the target item 510 is compliant. In one form, the key-value pair 528 includes a first key including a decision 530 as to whether the target item is compliant, and a second key including a reason 532 (also referred to herein as an explanation) for the decision 530. In one form, key-value pairs 528 indicating non-compliant items are stored and used as training data for the rule generation language model 502.

In some aspects, the rule retrieval language model 504 generates training data including the plurality of misclassifications of items used to train the rule generation language model 502. In one form, the rule generation language model 502 and the rule retrieval language model 504 may be different language models, while in other forms, the rule generation language model 502 and the rule retrieval language model 504 may be the same language model. In one form, it is contemplated that the processing resource 102 operates via one or more trained models 118 acting as LLM agents. In this form, the trained model(s) 118 are analogous to the rule generation component 501 and the rule retrieval component 503 and interface with the rule generation language model 502 and the rule retrieval language model 504, respectively. In one form, these trained models 118 may train the rule generation language model 502 to generate the dynamic rules 512 and/or may generate the prompt 526 to query the rule retrieval language model 504 to apply the dynamic rules 512 to determine if the target item is compliant.

In one form, the processing resource 102 and the machine readable medium 104 are part of a cloud computing system and at least one of the rule generation language model 502 and the rule retrieval language model 504 are executed by the cloud computing system. In one form, the rule generation language model 502 may be a larger language model (such as, for example, GPT 4.0) in comparison to the rule retrieval language model 504 (such as, for example, GPT 3.5). In one form, it has been found that a larger language model may be desirable because it may make fewer assumptions and overgeneralizations and may engage in more nuanced decision making than a smaller language model.

In some forms, smaller LLMs may be used to generate training data for the rule generation language model 502, which is a larger LLM. In one form, a set of labeled data may be used to uncover potential patterns and rules for accurate future predictions. The rule generation language model 502 may be employed to determine these patterns and rules. In one form, the rule generation language model 502 may be presented with data points with a false prediction from a smaller language model (such as, for example, GPT 3.5) and may be asked to explain the mistake and create a general rule for future instances. The result may be a list of explanations and corresponding rules for misclassified data points. In one form, these rules, partitioned by each keyword, may provide common reasons for misclassifications for the keyword by the smaller language model.

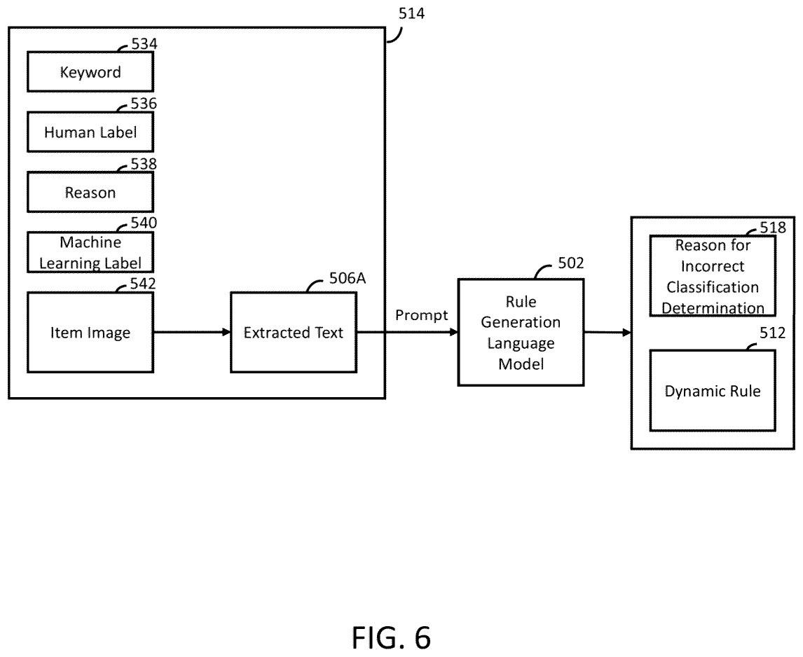

FIG. 6 depicts a block diagram of an example of generation of a dynamic rule as performed by the example system 500. In one form, a misclassification example 514 is input into the rule generation language model 502. In one form, the misclassification example 514 may include a keyword 534, a human label 536, a reason 538 for the human label 536, a machine learning label 540, and an item image 542. In one form, the human label 536 is a classification determination regarding an item. In one form, the machine learning label 540 is a classification determination regarding an item that contradicts the human label 536. In other words, the machine learning label 540 is an incorrect classification determination for an item. Extracted text 506A is extracted from an item image 542 associated with an incorrectly classified item. The misclassification example 514 and the extracted text 506A may be populated into a prompt which is utilized by the rule generation language model 502 to generate a dynamic rule 512 and a reason 518 for the incorrect classification determination.

In one example, the keyword 534 is “tetracycline”. In other words, items with “tetracycline” as an ingredient may be considered as non-compliant. The extracted text 506A taken from the item image 542 may state: “solution for smoked stains, tea stains, coffee stains, red wine stains, food coloring, betel nut stains, and tetracycline oxidation and decolorization of yellow teeth and black teeth caused by stubborn tooth stains”. In the present example, the human label 536 for the compliance assessment is “yes” with the reason 538 being “because ‘tetracycline’ is not an active ingredient”. In the present misclassification example 514, the machine learning label 540 is “no”, possibly because the keyword was found in the extracted text without consideration of context.

Based on the misclassification example 514 provided, the rule generation language model 502 then determines a reason 518 for the incorrect classification determination in the machine learning label 540. The rule generation language model 502 may determine the following reason 518: “The labeler's assessment is incorrect because tetracycline is not an ingredient in the product but rather a cause for the stains that the product aims to remove. The product is a teeth whitening solution designed to address various types of stains, including those caused by tetracycline oxidation. The labeler may have misunderstood the context in which tetracycline was mentioned and assumed it was an ingredient, when in fact, it is a type of stain that the product is designed to treat”. The rule generation language model 502 may create the following dynamic rule 512: “In future cases, the labeler should carefully differentiate between the ingredients present in a product and the issues or conditions that the product aims to address, ensuring that only actual components are classified as ingredients”.

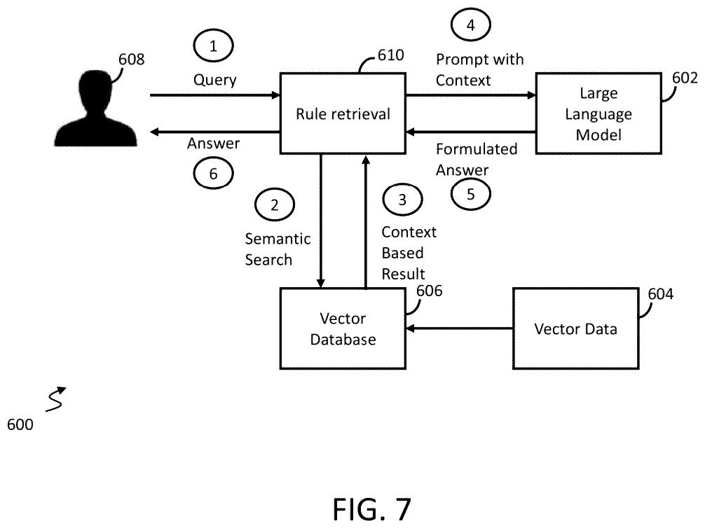

FIG. 7 depicts a block diagram of an example system 600 that uses language models to perform retrieval augmented generation. This system 600 shows an example of retrieval augmented generation, such as may be used in system 500 shown in FIG. 5. FIG. 7 depicts an example of how the processing resource 102 uses language models to contextually retrieve data. In one form, it is generally contemplated that the language model 602 is analogous to the rule retrieval language model 504; the vector data 604 is analogous to the dynamic rules 512; the vector database 606 may be analogous to the vector database 508; and the rule retrieval component 610 may be analogous to the rule retrieval component 503. In one form, the rule retrieval component 610 may be in the form of an LLM agent and/or trained model that may act as an interface and operate in conjunction with the language model 602.

In one form, it is generally contemplated that systems 500 and 600 may utilize a certain type of database, known as a vector database 508, 606 (vector indices may also be used), that may be used to store dynamic rules 512. A vector database may index and store vector embeddings, which are data in the form of vector data representations. These data may include semantic/language information that is useful for artificial intelligence and machine learning. In some forms, this type of data may facilitate the understanding of patterns and relationships, which may be desirable with respect to dynamic rules 512 and their application.

In one form, a user 608 enters a query through a rule retrieval component 610. In one form, the rule retrieval component 610 may utilize a user interface through which a user 608 may enter a query and receive an answer to the query. The rule retrieval component 610 may communicatively couple components of the system 600 including the language model 602 and the vector database 606. The rule retrieval component 610 may then perform a semantic search of vector data 604 stored in the vector database 606, the semantic search being associated with the query entered by the user 608. In one form, the rule retrieval component 610 may then receive a context-based result that includes relevant vector data 604 following the semantic search, such as indexed vector data 604 that is close to the query. In one form, it is contemplated that the vector database 606 is used in conjunction with a retrieval augmented approach.

In one form, the rule retrieval component 610 then populates a prompt with the context-based result and provides the prompt to the language model 602. The language model 602 may then formulate and provide an answer to the rule retrieval component 610, which, in turn, provides the answer to the user 608. In other words, the system 600 retrieves contextual information relevant to a query and utilizes the contextual information to prompt a language model 602 to formulate an answer to the query.

In one form, as stated, the rule retrieval component 610 may be analogous to the rule retrieval component 503 of FIG. 5. For example, the rule retrieval component 610 may retrieve dynamic rules from a database and populate a template (such as the prompt template 522) with the dynamic rules in order to provide a completed prompt (such as the prompt 526) to the language model 602 in order to determine the compliance of an item with context. The user 608 provided query may include a keyword to be utilized in a compliance assessment.

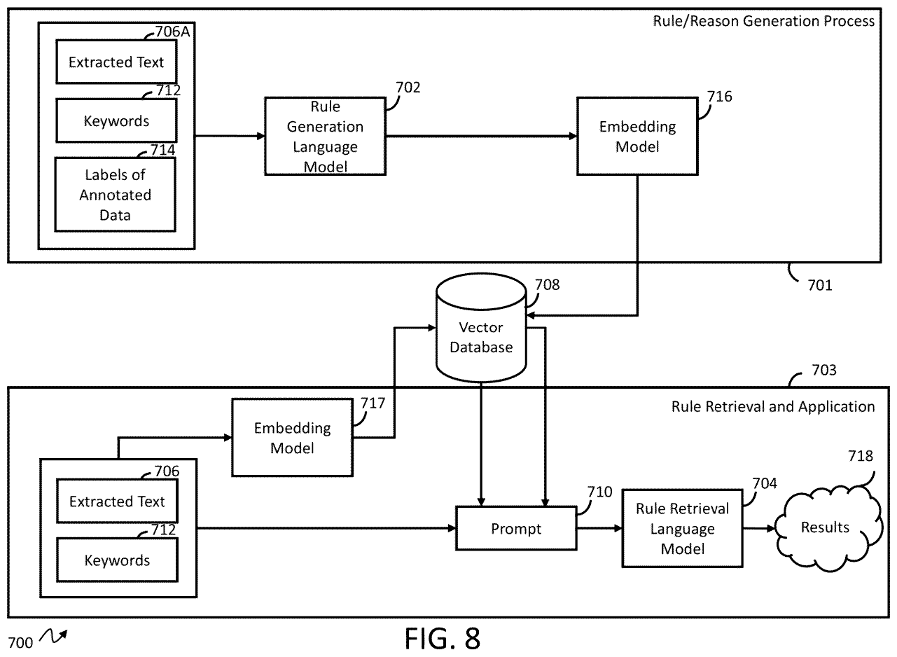

FIG. 8 depicts a block diagram of an example system 700 showing an example of vector embedding in a vector database and the relationship to rule generation and rule retrieval. In one form, it is generally contemplated that rule generation component 701 may be analogous to the rule generation component 501; the rule generation language model 702 may be analogous to the rule generation language model 502; the rule retrieval component 703 may be analogous to the rule retrieval component 503; the rule retrieval language model 704 may be analogous to the rule retrieval language model 504; the extracted text 706, 706A may be analogous to the extracted text 506, 506A; the vector database 708 may be analogous to the vector database 508; and the prompt 710 may be analogous to the prompt 526.

In one form, the rule generation component 701 generates dynamic rules based on misclassification examples. In one form, a misclassification example includes extracted text 706A from an image of a non-compliant item, keyword(s) 712, and labels of annotated data 714. In one form, the labels of annotated data 714 may include the human label 536 and the machine learning label 540 depicted in FIG. 6. In one form, in a misclassification example, the human label (determined by a user) and the machine learning label (determined by a language model) do not match. In one form, the rule generation language model 702 receives the misclassification example and generates dynamic rules (such as the dynamic rules 512). In one form, an embedding model 716 converts the dynamic rules into vector data (such as the vector data 604) and stores and indexes the vector data in the vector database 708. In some forms, the embedding model 716 receives text as input and generates vectors of numbers as output that are indexed so as to be readily searchable.

In one form, the rule retrieval component 703 retrieves dynamic rules (in the form of vector data) and assesses a target item for compliance utilizing the dynamic rules. The rule retrieval component 703 may include an embedding model 717 that converts extracted text 706 and keyword(s) 712 associated with a target item into vector data and stores the vector data in the vector database 708. It is generally contemplated that the embedding model 717 is the same as embedding model 716, but it may be a different one. In one form, the vector embeddings from the embedding model 717 are used to query the vector database 708 for similar vector embeddings that were previously stored and indexed.

In one form, following the query, one or more keyword specific dynamic rules may be retrieved from the vector database 708 and populated into the prompt 710. In one form, the populated prompt 710 is utilized by the rule retrieval language model 704 to determine an item's compliance. A compliance determination may be output, for example, as results 718 by the rule retrieval language model 704.

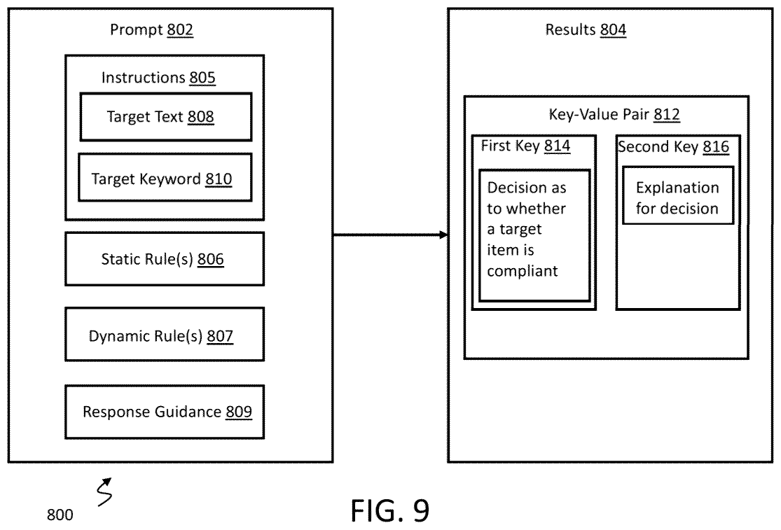

FIG. 9 depicts a block diagram showing an example system 800 that includes a prompt 802 involving an item and generated results 804 in the form of a key-value pair. In this form, it is generally contemplated that this prompt 802 corresponds to the prompt 526 and/or prompt 710 in FIGS. 5 and 8, respectively. The prompt 802 may include natural language text, structured text, target text extracted from target images within a catalog, any other text format, and/or combinations thereof.

In this example, the prompt 802 includes the following instructions 805: “As a Health and Wellness catalog expert, analyze the following e-commerce product label text: ‘ultimate nutrition® platinum series ultra ripped may boost metabolism*daily pre may help burn fat*during ephedra free post night thermogenic dietary supplement 180 capsules genuine’. Next, determine whether the following element is used in the product's manufacture: ‘ephedra’”. In this example, the e-commerce product label text may be target text 808 extracted from a target image in a listing/catalog, such as, for example, an image of a dietary supplement. Further, in this example, the target keyword 810 is “ephedra”, which may represent a prohibited ingredient in a non-compliant item.

Next, in this example, the prompt 802 includes the following static rules 806: “Evaluation Guidelines: 1. If the element is an active ingredient in the product, the decision is ‘yes’. 2. If the element is an inactive ingredient in the product, the decision is ‘no’. 3. If the element is mentioned in the warning, caution, or general info section but not as a product ingredient, the decision is ‘no’. 4. If the element is associated with the product but not used in manufacturing, the decision is ‘no’. These static rules 806 may be included uniformly in all (or most) prompts, as described above in systems 300 and 500.

Further, in this example, the prompt 802 includes the following dynamic rule 807: “Crosscheck with: 1. Rule: If the product description specifically states that the product is ‘element-free’ and the specific element is not listed in both the active and inactive ingredients, then the specific element is not used in the manufacturing of the product.” In one form, this dynamic rule 807 may be retrieved using a retrieval augmentation approach. Further, in one form, a rule retrieval component may retrieve this dynamic rule 807 from a vector database where dynamic rules are stored and indexed, such as described above in systems 300, 400, 500, 600, and 700.

In some forms, the prompt 802 may include response guidance 809 for the intended output, e.g., specifying one or more of the form or format of the response, words/phrases to avoid, and requesting that the language model not hallucinate (i.e., base its answers on the information given and not make up answers or information). In this example, the prompt 802 includes the following response guidance 809: “Please present your decision and explanation in the following JSON format: {‘decision’: ‘yes/no/not_sure’, ‘message’: ‘Your detailed explanation for the decision’}. Here, ‘decision’ is your final conclusion, and ‘message’ is the detailed reasoning behind your decision. Ensure both are in sync.”After the prompt 802 is inputted, the system 800 generates the results 804. More specifically, after querying a rule retrieval language model, the rule retrieval language model generates a compliance decision. The compliance decision may be in the form of a key-value pair 812 including a first key 814 and a second key 816. In one form, the first key 814 includes a decision as to whether the target item, e.g., the dietary supplement, is non-compliant, and the second key 816 includes an explanation for the decision. In this example, the key-value pair 812 includes the following: “Model's Decision: {‘decision’: ‘no’, ‘message’: ‘Based on the evaluation guidelines and crosschecking with the rule, the decision is ‘no’. The item description mentions ‘ephedra free’, indicating that the item does not contain ephedra as an ingredient in manufacturing.’} ”. In this example, the decision “no” indicates that the element was not used in the product's manufacture and is therefore compliant. It should be understood that this “ephedra” example is provided for illustrative purposes and that other types of items and keywords may be the subject of this approach.

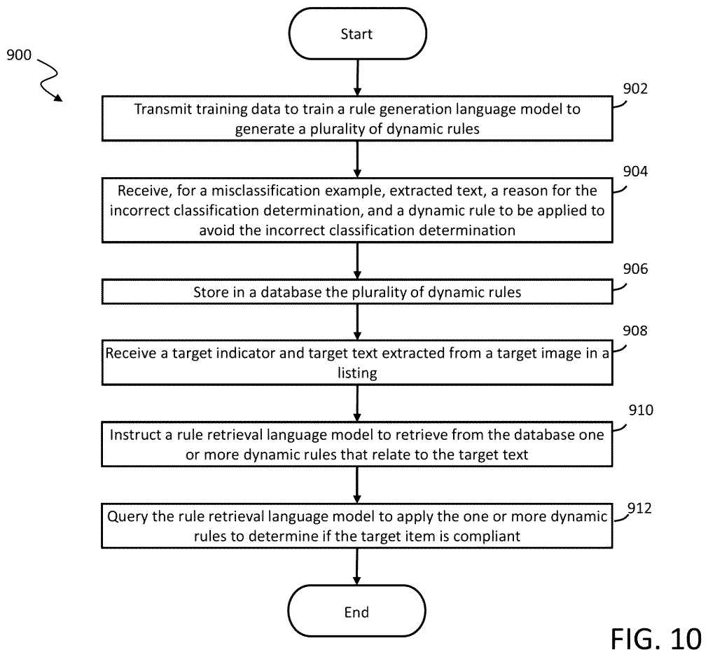

FIG. 10 depicts a flow diagram showing an exemplary method. In some forms, one or more blocks of the method may be performed at about the same time or in a different order than illustrated in the figures. In some forms, the method may not include all of the blocks/steps shown, may include additional blocks/steps, and/or some blocks/steps may be combined. In some forms, some of the blocks/steps may be repeated. It is generally contemplated that the method may be implemented in conjunction with executable instructions stored on a machine readable medium and a processing resource. Additionally, some aspects of the method for operation may incorporate some of the components shown in FIGS. 1-9, such as the processing resource 102. Further, in one form, it is contemplated that the processing resource may perform the functionality described in the blocks/steps below via LLM agents and/or trained models that serve as interfaces to the rule generation and rule retrieval language models.

FIG. 10 depicts a flow diagram with a process 900 that may be used to determine item compliance. At block 902, training data is transmitted to train a rule generation language model to generate a plurality of dynamic rules. In one form, the training data includes examples of misclassifications of items, each example including extracted text and an incorrect classification determination that the extracted text was associated with a non-compliant item. In one form, it is contemplated that a processing resource transmits the training data to the rule generation language model.

At block 904, a misclassification example, extracted text, a reason for the incorrect classification determination, and a dynamic rule to be applied that avoids the misclassification example are received. In one form, it is contemplated that a processing resource receives the misclassification example, extracted text, reason for the incorrect classification determination, and dynamic rule. At block 906, the plurality of dynamic rules that avoid the incorrect classification determinations from the plurality of misclassifications of items are stored in a database. In one form, a processing resource stores the dynamic rules in the database.

At block 908, a target keyword and target text extracted from a target image in a listing, or catalog, are received. In one form, the catalog includes a plurality of images associated with a plurality of items, the target image contains the target keyword and is associated with a target item, and the target keyword indicates a possibly non-compliant item not authorized to be in the catalog. In one form, a processing resource receives the target keyword and target text.

At block 910, a rule retrieval language model retrieves one or more dynamic rules that relate to the target text from the database. In one form, a processing resource instructs the rule retrieval model to retrieve the dynamic rules. Further, in one form, this retrieval may be perform using a retrieval augmented generation approach to retrieve relevant dynamic rule(s) stored in a vector database.

At block 912, the rule retrieval language model is queried to apply the one or more dynamic rules to determine if the target item is compliant. In one form, a prompt is transmitted to the rule retrieval language model to determine if the target item is compliant, and the prompt may include the target keyword, the target text, the dynamic rule(s) related to the target text, and static rule(s) applied without a determination of a relationship to the target text. In one form, an instruction is transmitted to the rule retrieval language model to provide a key-value pair as output to the prompt to determine if the target item is compliant. The key-value pair may include a first key including a decision as to whether the target item is compliant and a second key including an explanation for the decision. In one form, a processing resource queries the rule retrieval language model to determine if the target item is compliant.

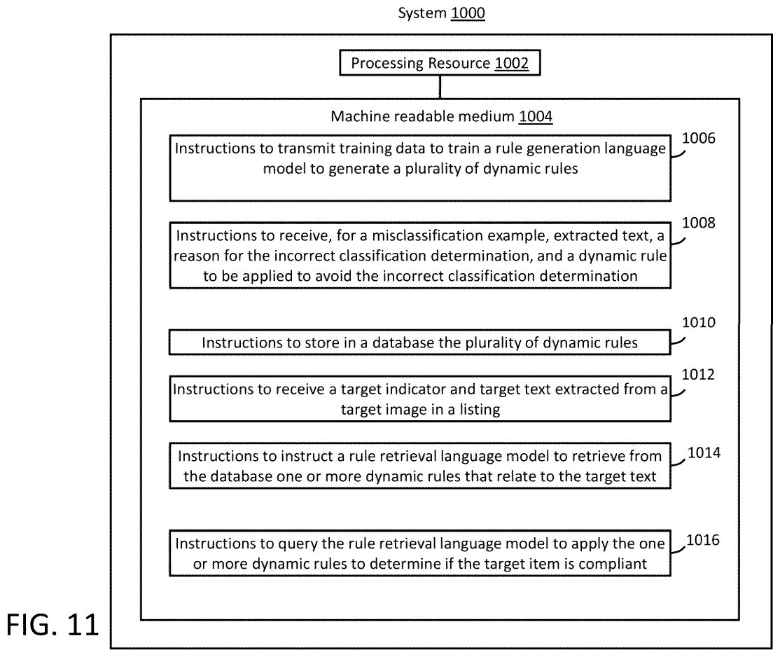

FIG. 11 depicts an example system 1000 that includes a non-transitory, machine readable medium 1004 that is encoded with example instructions executable by a processing resource 1002. In some forms, the system 1000 may be useful for implementing aspects of the systems 100, 300, 400, 500, 600, 700 of FIGS. 1-8 or for performing aspects of the process 900 of FIG. 10. For example, the instructions encoded on the machine readable medium 1004 may be included in instructions 105 of FIG. 1.

The processing resource 1002 may include a microcontroller, a microprocessor, central processing unit core(s), an ASIC, an FPGA, and/or other hardware device suitable for retrieval and/or execution of instructions from the machine readable medium 1004 to perform functions related to various examples. Additionally, or alternatively, the processing resource 1002 may include or be coupled to electronic circuitry or dedicated logic for performing some or all of the functionality of the instructions described herein. Further, in one form, it is contemplated that the processing resource may perform the functionality described in the blocks/steps below via LLM agents and/or trained models that serve as interfaces to the rule generation and rule retrieval language models.

The machine readable medium 1004 may be of any medium suitable for storing executable instructions, such as RAM, ROM, EEPROM, flash memory, a hard disk drive, an optical disc, or the like. In some examples, the machine readable medium 1004 may be a tangible, non-transitory medium. The machine readable medium 1004 may be disposed within the systems 100, 300, 400, 500, 600, 700, in which case the executable instructions may be deemed installed or embedded on the system. Alternatively, the machine readable medium 1004 may be a portable (e.g., external) storage medium.

As described further herein below, the machine readable medium 1004 may be encoded with a set of executable instructions. It should be understood that part or all of the executable instructions and/or electronic circuits included within one box may, in alternate forms, be included in a different box shown in the figures or in a different box not shown. Some implementations may include more or fewer instructions than are shown in FIG. 11.

In FIG. 11, instructions may be used to determine item compliance. Instructions 1006, when executed, cause the processing resource 1002 to transmit training data to train a rule generation language model to generate a plurality of dynamic rules. The training data may include a plurality of examples of misclassifications of items, each example including extracted text and an incorrect classification determination that the extracted text was associated with a non-compliant item. Instructions 1008, when executed, cause the processing resource 1002 to receive, for a misclassification example, extracted text, a reason for the incorrect classification determination, and a dynamic rule to be applied to avoid the incorrect classification determination. Instructions 1010, when executed, cause the processing resource 1002 to store the plurality of dynamic rules that avoid the incorrect classification determinations from the plurality of examples of misclassifications of items in a database.

Instructions 1012, when executed, cause the processing resource 1002 to receive a target indicator and target text extracted from a target image in a listing, or catalog. The listing may include a plurality of images associated with a plurality of items, the target image containing the target indicator (or keyword) and being associated with a target item, and the target indicator indicating a possibly non-compliant item not authorized to be in the listing. Instructions 1014, when executed, cause the processing resource 1002 to instruct a rule retrieval language model to retrieve from the database one or more dynamic rules that relate to the target text. Instructions 1016, when executed, cause the processing resource 1002 to query the rule retrieval language model to apply the one or more dynamic rules to determine if the target item is complaint.

Generally speaking, pursuant to various embodiments, systems, apparatuses, and methods are provided herein useful to product compliance. In some embodiments, there is provided a system including: a listing database containing a listing including a plurality of images associated with a plurality of items; a processing resource; and a machine readable medium storing instructions. The instructions, when executed by the processing resource, cause the processing resource to: transmit training data to train a rule generation language model to generate a plurality of dynamic rules, the training data comprising a plurality of examples of misclassifications of items, each example comprising extracted text and an incorrect classification determination that the extracted text was associated with a non-compliant item; receive, for a misclassification example, the extracted text, a reason for the incorrect classification determination, and a dynamic rule to be applied that avoids the incorrect classification determination; store in a rules database the plurality of dynamic rules that avoid the incorrect classification determinations from the plurality of examples of misclassifications of items; receive a target indicator that may indicate a non-compliant item not authorized to be in the listing; receive target text extracted from a target image in the listing containing the target indicator and associated with a target item; instruct a rule retrieval language model to retrieve from the rules database one or more dynamic rules that relate to the target text; and query the rule retrieval language model to apply the one or more dynamic rules to determine if the target item is compliant.

In some implementations, the machine readable medium storing instructions, when executed by the processing resource, causes the processing resource to: transmit a prompt to the rule retrieval language model to determine if the target item is compliant, the prompt including the target text, the one or more dynamic rules related to the target text, and one or more static rules applied without a determination of a relationship to the target text. In some implementations, the machine readable medium storing instructions, when executed by the processing resource, causes the processing resource to: transmit an instruction to the rule retrieval language model to provide a key-value pair as output to the prompt to determine if the target item is compliant, the key-value pair including a first key including a decision as to whether the target item is compliant and a second key including an explanation for the decision. In some implementations, key-value pairs indicating non-compliant items are stored and used as training data for the rule generation language model. In some implementations, the rules database includes a vector database, the system further including: an embedding model that converts the plurality of dynamic rules to vector data and stores the vector data in the vector database. In some implementations, the rule retrieval language model uses retrieval augmented generation to determine the one or more dynamic rules related to the target text. In some implementations, the rule retrieval language model generates the training data including the plurality of examples of misclassifications of items used to train the rule generation language model. In some implementations, the rule generation language model and the rule retrieval language model are different language models. In some implementations, the system further includes at least one trained model to train the rule generation language model to generate the plurality of dynamic rules and/or to generate a prompt to query the rule retrieval language model to apply the one or more dynamic rules to determine if the target item is compliant. In some implementations, the processing resource and the machine readable medium are part of a cloud computing system and at least one of the rule generation language model and the rule retrieval language model are executed by the cloud computing system.

In another form, there is provided a method including: transmitting training data to train a rule generation language model to generate a plurality of dynamic rules, the training data including a plurality of examples of misclassifications of items, each example including extracted text and an incorrect classification determination that the extracted text was associated with a non-compliant item; receiving, for a misclassification example, the extracted text, a reason for the incorrect classification determination, and a dynamic rule to be applied that avoids the incorrect classification determination; storing in a rules database the plurality of dynamic rules that avoid the incorrect classification determinations from the plurality of examples of misclassifications of items; receiving a target indicator and target text extracted from a target image in a listing, the listing including a plurality of images associated with a plurality of items, the target image containing the target indicator and associated with a target item, the target indicator indicating a possibly non-compliant item not authorized to be in the listing; instruct a rule retrieval language model to retrieve from the rules database one or more dynamic rules that relate to the target text; and querying the rule retrieval language model to apply the one or more dynamic rules to determine if the target item is compliant.

In some implementations, the method further includes transmitting a prompt to the rule retrieval language model to determine if the target item is compliant, the prompt including the target text, the one or more dynamic rules related to the target text, and one or more static rules applied without a determination of a relationship to the target text. In some implementations, the method further includes transmitting an instruction to the rule retrieval language model to provide a key-value pair as output to the prompt to determine if the target item is compliant, the key-value pair including a first key including a decision as to whether the target item is compliant and a second key including an explanation for the decision. In some implementations, the rules database includes a vector database, the method further including: by an embedding model, converting the plurality of dynamic rules to vector data and storing the vector data in the vector database; and by the rule retrieval language model, using retrieval augmented generation to determine the one or more dynamic rules related to the target text. In some implementations, the method further includes: by at least one trained language model, training the rule generation language model to generate the plurality of dynamic rules and/or generating a prompt to query the rule retrieval language model to apply the one or more dynamic rules to determine if the target item is compliant.

In another form, there is provided a non-transitory machine readable medium storing instructions that, when executed, cause a processing resource to: transmit training data to train a rule generation language model to generate a plurality of dynamic rules, the training data including a plurality of examples of misclassifications of items, each example including extracted text and an incorrect classification determination that the extracted text was associated with a non-compliant item; receive, for a misclassification example, the extracted text, a reason for the incorrect classification determination, and a dynamic rule to be applied that avoids the incorrect classification determination; store in a rules database the plurality of dynamic rules that avoid the incorrect classification determinations from the plurality of examples of misclassifications of items; receive a target indicator and target text extracted from a target image in a listing, the listing including a plurality of images associated with a plurality of items, the target image containing the target indicator and associated with a target item, the target indicator indicating a possibly non-compliant item not authorized to be in the listing; instruct a rule retrieval language model to retrieve from the rules database one or more dynamic rules that relate to the target text; and query the rule retrieval language model to apply the one or more dynamic rules to determine if the target item is compliant.

In some implementations, the instructions, when executed, cause the processing resource to transmit a prompt to the rule retrieval language model to determine if the target item is compliant, the prompt comprising the target text, the one or more dynamic rules related to the target text, and one or more static rules applied without a determination of a relationship to the target text. In some implementations, the instructions, when executed, cause the processing resource to transmit an instruction to the rule retrieval language model to provide a key-value pair as output to the prompt to determine if the target item is compliant, the key-value pair including a first key including a decision as to whether the target item is compliant and a second key including an explanation for the decision. In some implementations, the rules database includes a vector database, an embedding model converts the plurality of dynamic rules to vector data and stores the vector data in the vector database, and the rule retrieval language model uses retrieval augmented generation to determine the one or more dynamic rules related to the target text. In some implementations, at least one trained model trains the rule generation language model to generate the plurality of dynamic rules and/or generates a prompt to query the rule retrieval language model to apply the one or more dynamic rules to determine if the target item is compliant.

Those skilled in the art will recognize that a wide variety of other modifications, alterations, and combinations can also be made with respect to the above described embodiments without departing from the scope of the disclosure, and that such modifications, alterations, and combinations are to be viewed as being within the ambit of the inventive concept.

1. A system comprising:
a listing database containing a listing including a plurality of images associated with a plurality of items;
a processing resource; and
a machine readable medium storing instructions that, when executed by the processing resource, cause the processing resource to:
extract text from the plurality of images using an image-to-text extraction process to generate extracted text;
transmit training data to train a rule generation language model to generate a plurality of dynamic rules, the training data comprising a plurality of examples of misclassifications of items, each example comprising:
extracted text extracted from an image associated with a respective item;
a target indicator included in or associated with the extracted text;
an incorrect machine-generated classification determination indicating that the respective item was non-compliant based on the extracted text;
a reviewer label indicating that the respective item was compliant; and
a reason for the reviewer label identifying contextual information in the extracted text that distinguishes use of the target indicator from an indication that the respective item is non-compliant;
receive, from the rule generation language model for each of the plurality of examples of misclassifications of items, an explanation of the incorrect machine-generated classification determination and a corresponding dynamic rule generated from the extracted text, the target indicator, the incorrect machine-generated classification determination, the reviewer label, and the reason for the reviewer label, the corresponding dynamic rule specifying a contextual condition for avoiding a subsequent classification determination that an item is non-compliant based merely on presence of the target indicator in extracted text;
generate, using an embedding model, vector data corresponding to the plurality of dynamic rules;
store the vector data corresponding to the plurality of dynamic rules in a vector database configured to index the vector data according to semantic similarity;
receive a target indicator that may indicate a non-compliant item not authorized to be in the listing;
receive target text extracted, using the image-to-text extraction process, from a target image in the listing containing the target indicator and associated with a target item;
generate, using the embedding model, target vector data corresponding to the target text and the target indicator;
retrieve, from the vector database, one or more dynamic rules having vector data semantically similar to the target vector data; and
query a rule retrieval language model using a prompt that includes the target text, the target indicator, and the retrieved one or more dynamic rules to determine whether the target item is compliant, wherein the retrieved one or more dynamic rules cause the rule retrieval language model to evaluate contextual use of the target indicator in the target text when determining whether the target item is compliant.

2. The system of claim 1, wherein the machine readable medium storing instructions, when executed by the processing resource, causes the processing resource to:
transmit a prompt to the rule retrieval language model to determine whether the target item is compliant, the prompt comprising the target text, the retrieved one or more dynamic rules, and one or more static rules applied without a determination of semantic similarity to the target text or the target indicator.

3. The system of claim 2, wherein the machine readable medium storing instructions, when executed by the processing resource, causes the processing resource to:
transmit an instruction to the rule retrieval language model to provide a key-value pair as output to the prompt, the key-value pair comprising a first key including a decision as to whether the target item is compliant and a second key including an explanation identifying contextual use of the target indicator in the target text that supports the decision.

4. (canceled)

5. The system of claim 1,
wherein the vector database stores, for each dynamic rule of the plurality of dynamic rules, the vector data in association with the corresponding dynamic rule and contextual information used to generate the corresponding dynamic rule, the contextual information comprising the target indicator and the explanation of the incorrect machine-generated classification determination generated by the rule generation language model.

6. The system of claim 5, wherein the rule retrieval language model uses retrieval augmented generation by populating the prompt with the retrieved one or more dynamic rules and contextual information stored in association with the retrieved one or more dynamic rules before generating the decision as to whether the target item is compliant.

7. (canceled)

8. The system of claim 1, wherein the rule generation language model and the rule retrieval language model are different language models, and wherein the rule generation language model has greater model capacity than the rule retrieval language model and is used to generate the plurality of dynamic rules from the plurality of examples of misclassifications of items.

9. (canceled)

10. The system of claim 1, wherein the processing resource and the machine readable medium are part of a cloud computing system, and wherein the cloud computing system executes at least one of the rule generation language model, the embedding model, the vector database, or the rule retrieval language model to generate the plurality of dynamic rules, store the vector data, retrieve the one or more dynamic rules, and query the rule retrieval language model.

11. A method comprising:
extracting text from a plurality of images associated with a plurality of items in a listing using an image-to-text extraction process to generate extracted text;
transmitting training data to train a rule generation language model to generate a plurality of dynamic rules, the training data comprising a plurality of examples of misclassifications of items, each example comprising:
extracted text extracted from an image associated with a respective item;
a target indicator included in or associated with the extracted text;
an incorrect machine-generated classification determination indicating that the respective item was non-compliant based on the extracted text;
a reviewer label indicating that the respective item was compliant; and
a reason for the reviewer label identifying contextual information in the extracted text that distinguishes use of the target indicator from an indication that the respective item is non-compliant;
receiving, from the rule generation language model for each of the plurality of examples of misclassifications of items, an explanation of the incorrect machine-generated classification determination and a corresponding dynamic rule generated from the extracted text, the target indicator, the incorrect machine-generated classification determination, the reviewer label, and the reason for the reviewer label, the corresponding dynamic rule specifying a contextual condition for avoiding a subsequent classification determination that an item is non-compliant based merely on presence of the target indicator in extracted text;
generating, using an embedding model, vector data corresponding to the plurality of dynamic rules; storing the vector data corresponding to the plurality of dynamic rules in a vector database configured to index the vector data according to semantic similarity;
receiving a target indicator that may indicate a non-compliant item not authorized to be in the listing;
receiving target text extracted, using the image-to-text extraction process, from a target image in the listing containing the target indicator and associated with a target item;
generating, using the embedding model, target vector data corresponding to the target text and the target indicator;
retrieving, from the vector database, one or more dynamic rules having vector data semantically similar to the target vector data; and
querying a rule retrieval language model using a prompt that includes the target text, the target indicator, and the retrieved one or more dynamic rules to determine whether the target item is compliant, wherein the retrieved one or more dynamic rules cause the rule retrieval language model to evaluate contextual use of the target indicator in the target text when determining whether the target item is compliant.

12. The method of claim 11, further comprising:
transmitting a prompt to the rule retrieval language model to determine whether the target item is compliant, the prompt comprising the target text, the retrieved one or more dynamic rules, and one or more static rules applied without a determination of a semantic similarity to the target text or the target indicator.

13. The method of claim 12, further comprising:
transmitting an instruction to the rule retrieval language model to provide a key-value pair as output to the prompt, the key-value pair comprising a first key including a decision as to whether the target item is compliant and a second key including an explanation identifying contextual use of the target indicator in the target text that supports the decision.

14. The method of claim 11,
wherein storing the vector data comprises storing, in the vector database for each dynamic rule of the plurality of dynamic rules, the vector data in association with the corresponding dynamic rule and contextual information used to generate the corresponding dynamic rule, the contextual information comprising the target indicator and the explanation of the incorrect machine-generated classification determination generated by the rule generation language model.

15. The method of claim 14, wherein the rule retrieval language model uses retrieval augmented generation by populating the prompt with the retrieved one or more dynamic rules and contextual information stored in association with the retrieved one or more dynamic rules before generating the decision as to whether the target item is compliant.

16. A non-transitory machine readable medium storing instructions that, when executed, cause a processing resource to:
extract text from a plurality of images associated with a plurality of items in a listing using an image-to-text extraction process to generate extracted text;
transmit training data to train a rule generation language model to generate a plurality of dynamic rules, the training data comprising a plurality of examples of misclassifications of items, each example comprising:
extracted text extracted from an image associated with a respective item;
a target indicator included in or associated with the extracted text;
an incorrect machine-generated classification determination indicating that the respective item was non-compliant based on the extracted text;
a reviewer label indicating that the respective item was compliant; and
a reason for the reviewer label identifying contextual information in the extracted text that distinguishes use of the target indicator from an indication that the respective item is non-compliant;
receive, from the rule generation language model for each of the plurality of examples of misclassifications of items, an explanation of the incorrect machine-generated classification determination and a corresponding dynamic rule generated from the extracted text, the target indicator, the incorrect machine-generated classification determination, the reviewer label, and the reason for the reviewer label, the corresponding dynamic rule specifying a contextual condition for avoiding a subsequent classification determination that an item is non-compliant based merely on presence of the target indicator in extracted text;
generate, using an embedding model, vector data corresponding to the plurality of dynamic rules;
store the vector data corresponding to the plurality of dynamic rules in a vector database configured to index the vector data according to semantic similarity;
receive a target indicator that may indicate a non-compliant item not authorized to be in the listing;
receive target text extracted, using the image-to-text extraction process, from a target image in the listing containing the target indicator and associated with a target item;
generate, using the embedding model, target vector data corresponding to the target text and the target indicator;
retrieve, from the vector database, one or more dynamic rules having vector data semantically similar to the target vector data; and
query a rule retrieval language model using a prompt that includes the target text, the target indicator, and the retrieved one or more dynamic rules to determine whether the target item is compliant, wherein the retrieved one or more dynamic rules cause the rule retrieval language model to evaluate contextual use of the target indicator in the target text when determining whether the target item is compliant.

17. The non-transitory machine readable medium of claim 16,
wherein the instructions, when executed, cause the processing resource to transmit a prompt to the rule retrieval language model to determine whether the target item is compliant, the prompt comprising the target text, the retrieved one or more dynamic rules, and one or more static rules applied without a determination of semantic similarity to the target text or the target indicator.

18. The non-transitory machine readable medium of claim 17,
wherein the instructions, when executed, cause the processing resource to transmit an instruction to the rule retrieval language model to provide a key-value pair as output to the prompt, the key-value pair comprising a first key including a decision as to whether the target item is compliant and a second key including an explanation identifying contextual use of the target indicator in the target text that supports the decision.

19. The non-transitory machine readable medium of claim 16,
wherein the instructions, when executed, cause the processing resource to store, in the vector database for each dynamic rule of the plurality of dynamic rules, the vector data in association with the corresponding dynamic rule and contextual information used to generate the corresponding dynamic rule, the contextual information comprising the target indicator and the explanation of the incorrect machine-generated classification determination generated by the rule generation language model.

20. (canceled)

21. The system of claim 1, wherein retrieving the one or more dynamic rules comprises selecting the one or more dynamic rules from the vector database based on both the target indicator and semantic similarity between the target vector data and the vector data corresponding to the plurality of dynamic rules.

22. The system of claim 1, wherein the contextual condition specified by the corresponding dynamic rule comprises a negative-context condition indicating that the target indicator does not indicate non-compliance when the extracted text states that the target indicator is absent from, not used in, or not an ingredient of the respective item.

23. The system of claim 1, wherein querying the rule retrieval language model comprises populating a prompt template with the target text, the target indicator, the retrieved one or more dynamic rules, and response guidance specifying an output format comprising a compliance decision and an explanation for the compliance decision.

24. The system of claim 1, wherein generating the target vector data comprises applying the embedding model to the target text and the target indicator to generate the target vector data used to query the vector database.
